(19) United States
(12) Patent Application Publication
(10) Pub. No.: US 2015/0221172 A1
(43) Pub. Date: Aug. 6, 2015

(54) Online Banking Through a Gaming Console

(71) Applicant: Bank of America Corporation, Charlotte, NC (US)

(72) Inventors: Daniel P. Shnowske, Waxahachie, TX (US); William Scott Treadwell, Dallas, TX (US)

(21) Appl. No.: 14/687,182

(22) Filed: Apr. 15, 2015

Related U.S. Application Data
(63) Continuation of application No. 12/140,579, filed on Jun. 17, 2008.

(51) Int. Cl. G07F 17/32

(52) U.S. Cl. CPC G07F 17/3244

(57) ABSTRACT

Online banking using a gaming console may provide added security due to the hardened nature of gaming consoles. Additionally, console specific credentials may be used to verify that a user or console is authorized to access a requested financial account. The console specific credentials may be hardcoded in one or more hardware components of the gaming console so that the risks of exposure through tampering or hacking is reduced. User specific credentials and/or other information may also be used to further verify that a user or console is authorized to access a financial account. An integrity of the console may also be validated using console specific information. In one example, console integrity may be verified by a gaming service provider.

### BACKGROUND

Since its inception, online banking has faced many security obstacles. From keyloggers to phishers, an endless throng of security risks exist in the online banking industry. Despite the convenience and ease that online banking provides, consumers may steer away from online banking to avoid the dangers of electronic threats. Part of the danger results from the vast array of modifications hackers may make to their computing devices to attempt to circumvent the security measures instituted by financial institutions. In some instances, hackers may use certain devices to spoof the origin of online banking requests or install software to guess at user passwords. Additionally, consumers may simply avoid online banking due to their aversion to computers in general. Thus, while online banking provides conveniences, there remain issues that continue to discourage consumers from adopting the technology.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Aspects described herein relate to providing online banking through a dedicated or special-purpose gaming console. Gaming consoles are generally hardened devices (i.e., devices with standard parts and configurations) that are specifically designed for gaming and other types of entertainment. In contrast to general computing devices, gaming consoles are typically not as easily hacked or reconfigured due to their hardened nature. Accordingly, gaming consoles may offer an alternative for online banking. Additionally, with the explosive growth of the gaming industry, providing online banking through gaming consoles may allow financial institutions to tap into previously untouched markets. In practice, console integrity may be verified using console credentials that may be hardcoded into the gaming device. In addition, access to a financial account may be regulated by console and user specific credentials. Stated differently, authorization for access to a financial account may be given based on whether console and/or user specific credentials matches predefined information. In one arrangement, console specific credentials may be hardcoded into a chip in the console to prevent tampering and/or hacking. User specific credentials may also be used as an added level of protection. A gaming service provider may further be used to verify console integrity and, in some instances, to facilitate communication between a gaming console and the financial institution.

### BRIEF DESCRIPTION OF THE DRAWINGS

The present disclosure is illustrated by way of example and not limited in the accompanying figures in which like reference numerals indicate similar elements.

FIG. 1 illustrates a schematic diagram of a general-purpose digital computing environment in which aspects described herein may be used;

FIG. 2 is an illustrative block diagram of workstations and servers that may be used to implement one or more of the processes and functions of various embodiments;

FIG. 3 is a flowchart illustrating a method for accessing a financial account through a gaming console according to one or more aspects described herein;

FIG. 4 is a flowchart illustrating a method for verifying a game console requesting account access according to one or more aspects described herein;

FIGS. 5A and 5B illustrate information flows in various network configurations according to one or more aspects described herein;

FIG. 6 illustrates different passwords that may be used in a gaming console environment for logging into online banking;

FIG. 7 illustrates an example interface through which a user may login to a financial account; and

FIG. 8 illustrates an example interface through which a user may select a banking or gaming account profile.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

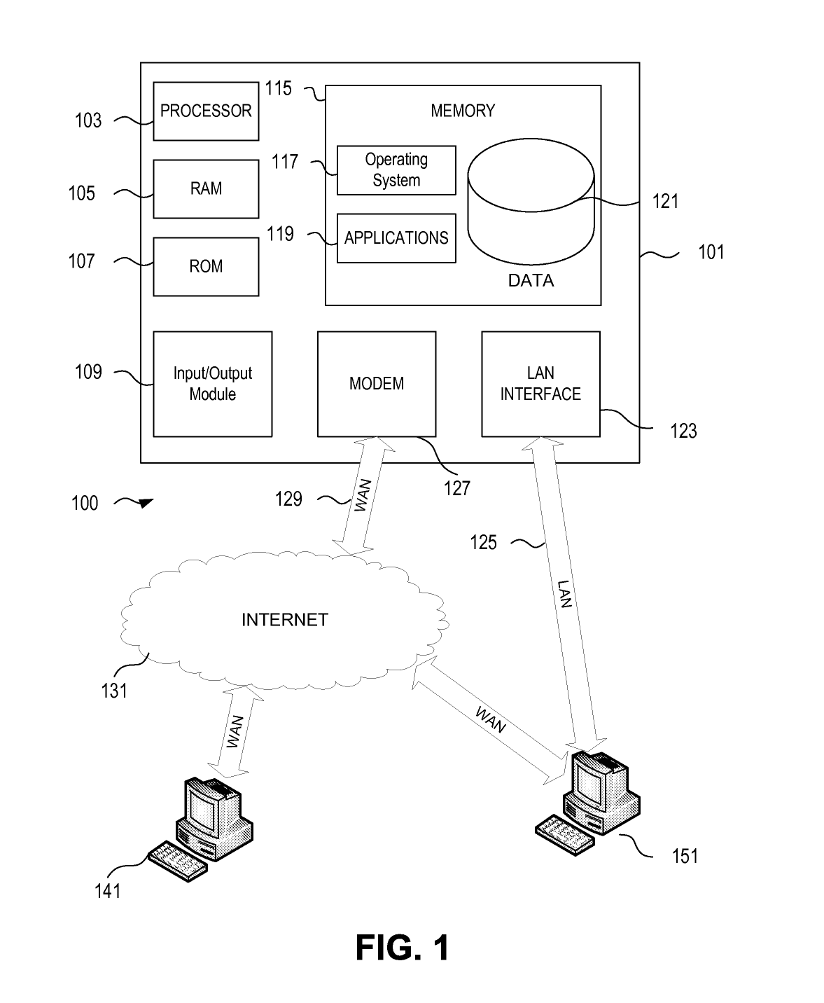

FIG. 1 illustrates a block diagram of a computing environment 100 including a generic computing device 101 (e.g., a computer server) that may be used according to an illustrative embodiment of the invention. The computer 101 may have a processor 103 for controlling overall operation of the server and its associated components, including RAM 105, ROM 107, input/output (I/O) module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of account information and account holder information for the entire business, allowing interoperability between different elements of the business residing at different physical locations.

The computer 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

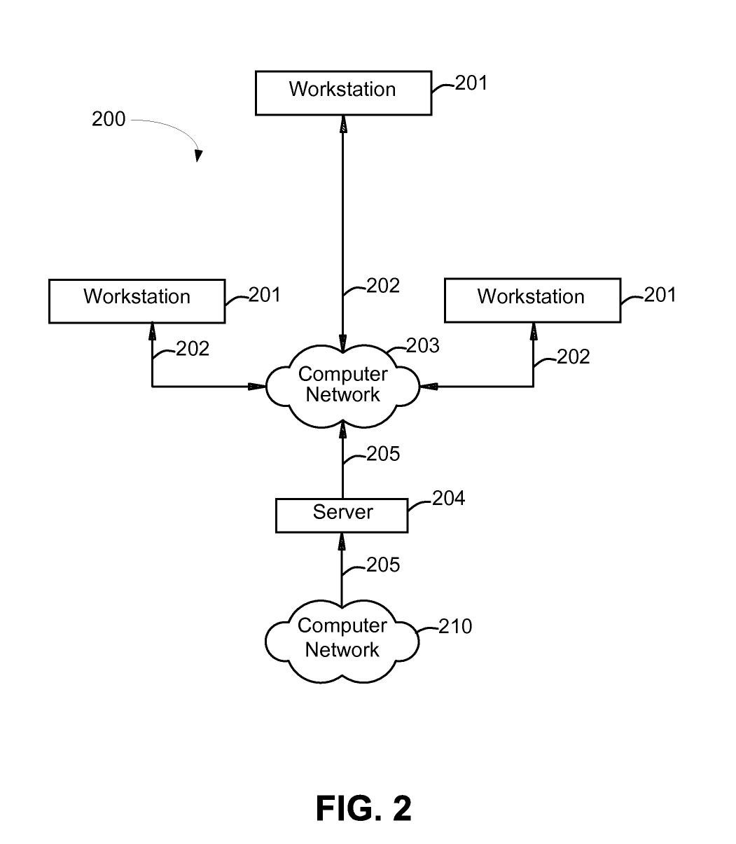

Referring to FIG. 2, an illustrative system 200 for implementing methods according to the present invention is shown. As illustrated, system 200 may include one or more workstations 201. Workstations 201 may be local or remote, and are connected by one or more communication links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

As understood by those skilled in the art, the steps that follow in the Figures may be implemented by one or more of the components in FIGS. 1 and 2 and/or other components, including other computing devices.

In one configuration described herein, computing device 101 of FIG. 1 may comprise a game console. A game console, as used herein, generally refers to a computing device that comprises dedicated gaming components (e.g., software, hardware, firmware, device connectors, etc.) and that is specifically configured for gaming. For example, a gaming console may have proprietary or generic input/output ports for game input devices having directional keys, a series of color or letter coded buttons, specific firmware or operating systems for executing game instructions, dedicated graphics and the like. A game console may further exist in a networked environment as illustrated in FIG. 2. According to one aspect, a game console may include a component such as a computer chip in which a hardware or console identifier and/or other information is hardcoded. Hardcoding an identifier and/or other information onto a piece of hardware such as a chip provides additional protection against hacking and other attempts to infiltrate computing devices. Console identification information or other data may be hardcoded in a manner such that if an intruder attempts to hack the console, the chip and the information stored therein may be destroyed.

Although most game consoles are designed with gaming in mind, some gaming consoles have evolved to include other capabilities as well. Thus, while one of the primary purposes of a gaming console is still to provide an enjoyable and immersive gaming experience, other activities such as web browsing and movie watching may also be performed on such consoles.

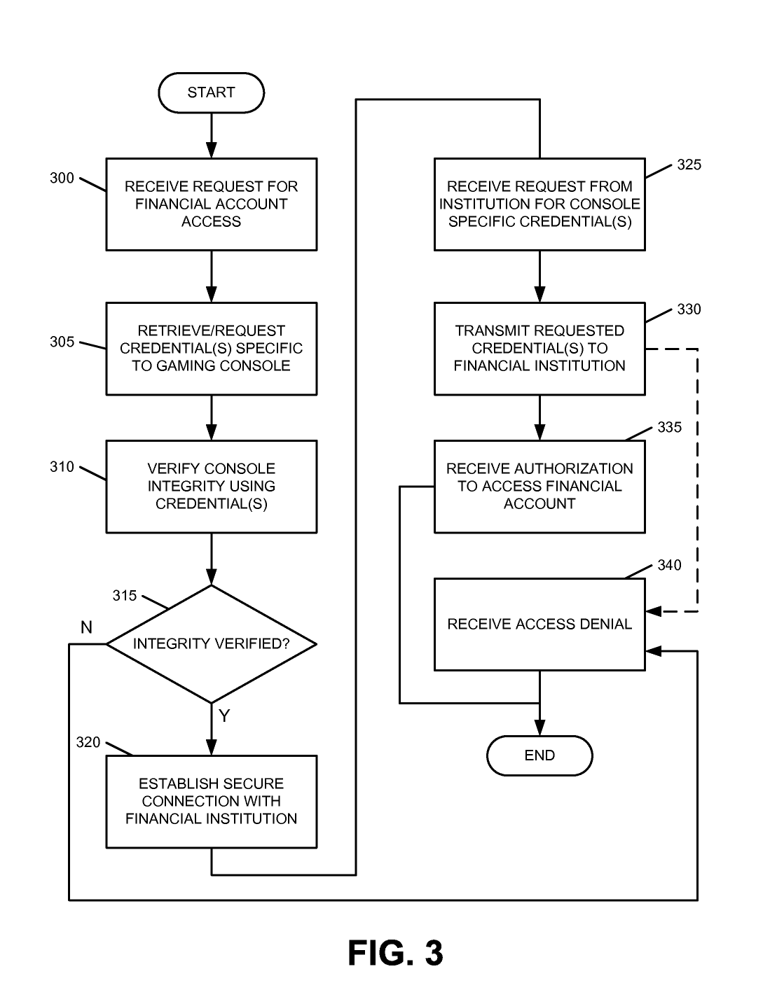

FIG. 3 is a flowchart illustrating a method for accessing an online banking system through a gaming console while maintaining a secure environment. In step 300, a gaming console may receive a request from a user to access a financial account. In one example, a user may select an online banking option in a main menu of the gaming console operating system causing an online banking application to be launched on the console. An online banking application may be distributed from a financial institution in the form of a digital download, a CD-ROM or other portable media among others.

In response to the user request, the game console may request or retrieve one or more credentials specific to the gaming console in step 305. In one arrangement, the one or more credentials may include a unique console identifier assigned by a manufacturer or supplier and hardcoded onto a console component (e.g., a chip). For example, a client side certificate or key unique to each console may be extracted from a hardware chip in the console. The application may then verify the integrity of the console using the one or more credentials in step 310. In one example, the gaming console may verify, with a game service provider, that the console has not been removed without authorization. A game service provider may track when consoles are removed without authorization and flag the corresponding console credentials accordingly. In one configuration, a game service provider may track the status of consoles based on reports submitted by the users of the consoles.

If console integrity is verified, as determined in steps 310 and 315, the console may subsequently establish a secure connection with a server of the financial institution associated with the financial account in step 320. In step 325, the gaming console and banking application may receive a request from the financial institution server for console specific credentials and/or user specific credentials such as an account identifier, a password, account number, gamer tag, gaming profile, a personal identification number (PIN) and the like. According to one configuration, a password may include characters or codes corresponding to input buttons such as a directional key on a game controller, movements of a joystick and/or a motion or series of motions (e.g., detected by a motion sensor), as is described in further detail below. This provides additional security by expanding the number of password or passcode permutations or possibilities. Additionally or alternatively, an account name or login name may be automatically determined based on a currently active gaming or user profile. For example, a login name may be automatically identified as the gamer tag associated with a particular user profile and thus, a user might not need to manually enter the user or account name.

In response to the request from the financial institution server, the gaming console may transmit the requested credentials to the financial institution server for validation and verification in step 330. If the credentials are validated and verified, the gaming console and banking application may subsequently receive authorization to access the financial account and conduct financial transactions from the financial institution server in step 335. Information sent to and from the gaming console may be encrypted or otherwise secured. Alternatively, if the credentials are not verified or validated, an access denial message may be received in step 340.

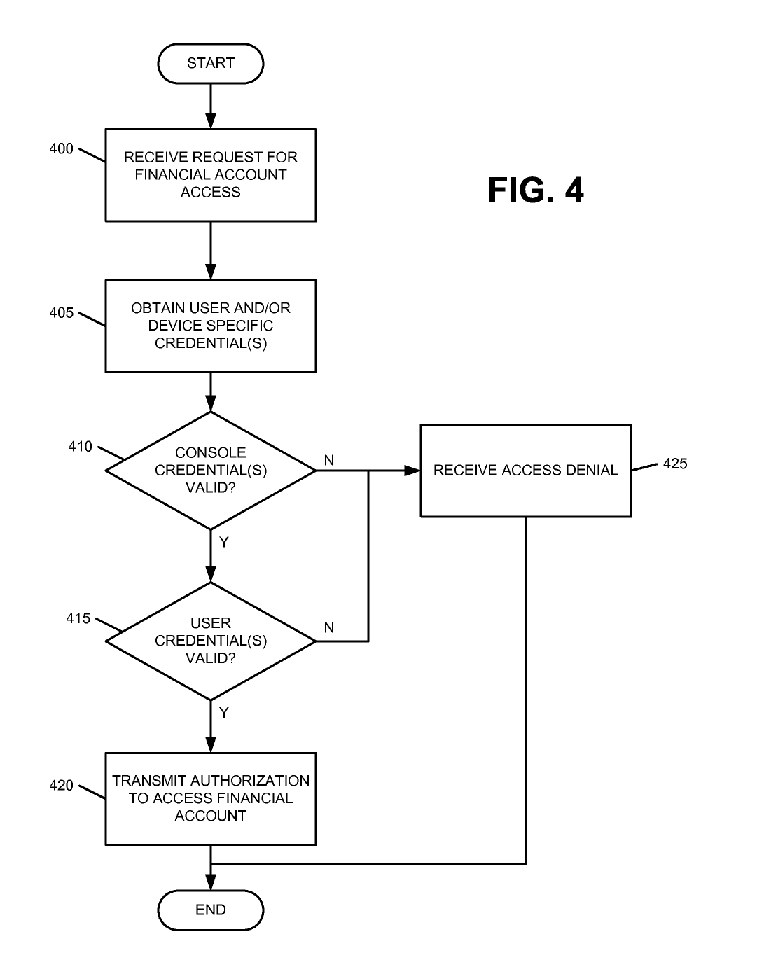

FIG. 4 illustrates a method for authorizing a user and console to access a financial account. In step 400, a financial institution may receive a request to access a financial account from a gaming console. The request may include one or more credentials for the console, the user, or both. If credentials are not included in the request, the financial institution may request the credentials. Regardless, the financial institution may obtain the one or more credentials in step 405 (e.g., by extraction from the request or requesting from the console/user). In step 410, the financial institution may determine whether the received console specific credentials are valid. The validation may be conducted in a variety of manners including verifying that the credentials match what is stored in an account information database. For example, user and/or console specific credentials may be collected and saved in association with a financial account during a registration process. If the console specific credentials are valid, the financial institution may optionally validate the user specific credentials in step 415. For example, if the user specific credentials include an account name and password, the name and password may be compared against what is stored in the account information database. If the user specific credentials are validated, the financial institution may then transmit an authorization to access the financial account to the gaming console in step 420. If, however, either the console specific credentials or the user specific credentials are not valid or cannot be verified, the financial institution may transmit a denial of access message to the console and user in step 425.

In one or more arrangements, the financial institution may further verify the integrity of the console by querying a remote gaming service provider with the one or more console specific credentials. The remote gaming service provider may be able to provide information regarding, the owner, whether the console has been removed without authorization, whether the console is registered or not registered with the service provider and the like. If the console specific credentials have been marked as removed without authorization or not registered, the financial institution may receive a response indicating such status information (e.g., indication that console integrity cannot be verified). Alternatively, if the console specific credentials are registered and/or does not indicate the console was removed without authorization, the financial institution may receive an indication that the console integrity is verified.

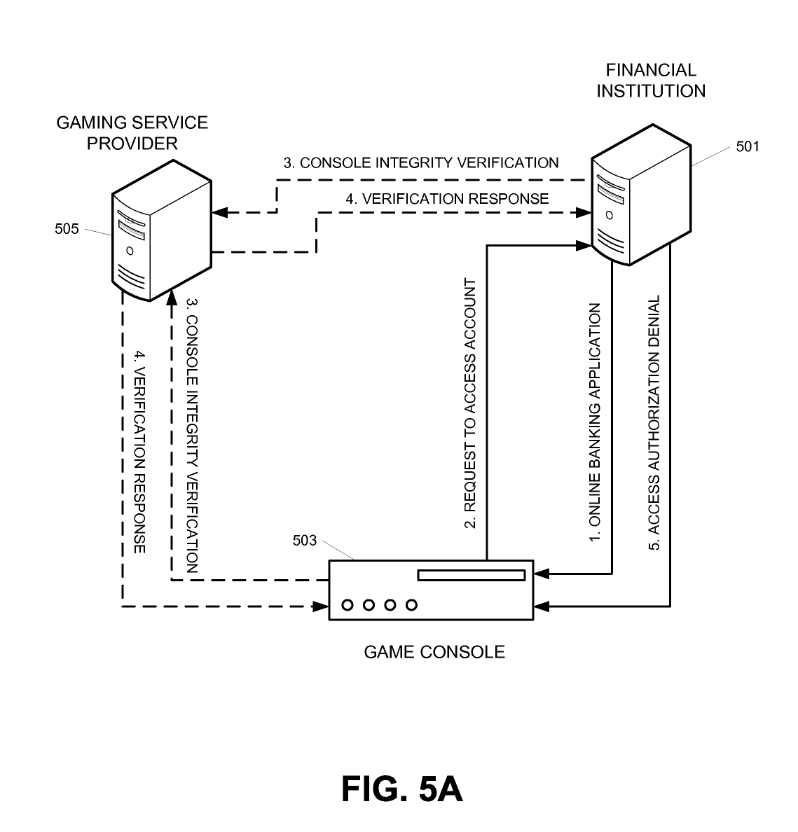

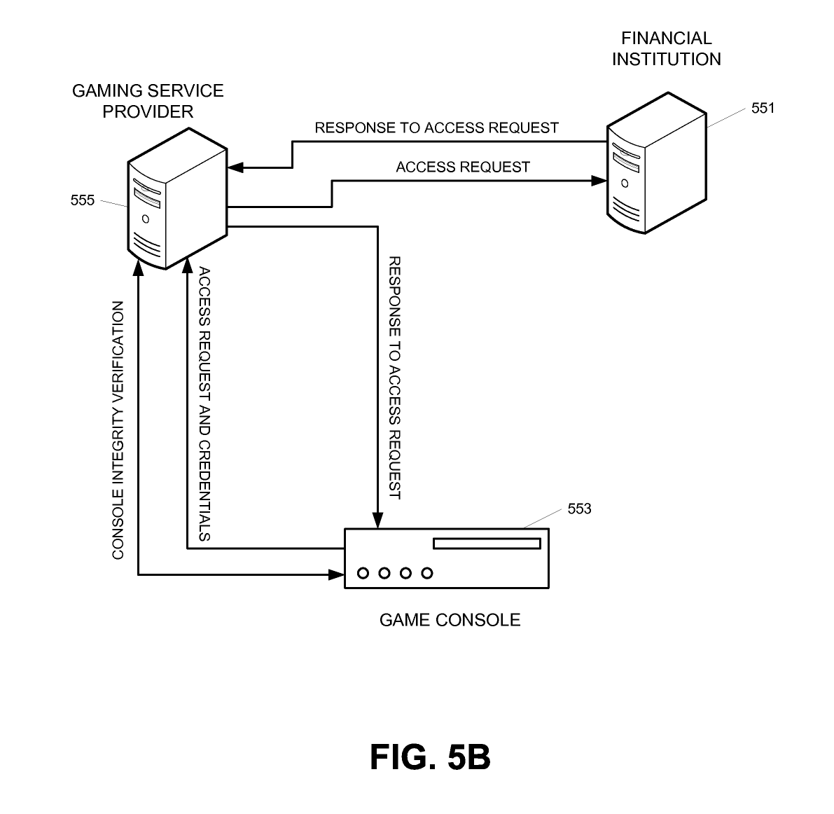

FIG. 5 illustrates a network diagram showing one example of a flow of information between a financial institution 501, a gaming console 503 and a gaming service provider 505. In particular, a financial institution 501 may initially transmit an online banking application configured to interface with the financial institution to gaming console 503. When online banking services are requested, the gaming console 503 may transmit console and user specific credentials to a financial institution 501 along with a request to access an account and/or perform a transaction. Console integrity may be verified by either the gaming console 503 (i.e., through the banking application) or by the financial institution 501. In one example, console integrity may be verified by sending a query to gaming service provider 505. Once verified, the financial institution 501 may further validate the credentials to determine if access is authorized. If so, the financial institution 501 may respond with a grant of access; however, if not, a response may include a denial of service.

FIG. 5B illustrates an alternative network diagram showing another flow of information between a financial institution 551, a gaming console 553 and a gaming service provider 555. Instead of gaming console 553 and financial institution 551 communicating directly with one another, gaming console 553 and financial institution 551 may communicate through gaming service provider 555. In particular, communications may be piggybacked on an existing network architecture established between gaming console 553 and gaming service provider 555. Accordingly, upon verifying the integrity of the gaming console 553, the gaming service provider 555 may forward console and/or user specific credentials to financial institution 551 for validation. Gaming service provider 555 may provide a secure transmission channel between gaming console 553 and financial institution 551 based on existing network protocols. Additionally, secure communications may be established between the financial institution 551 and the gaming service provider 555 without substantial risk of hacking or security circumvention that might exist by establishing direct communications with the gaming console 553.

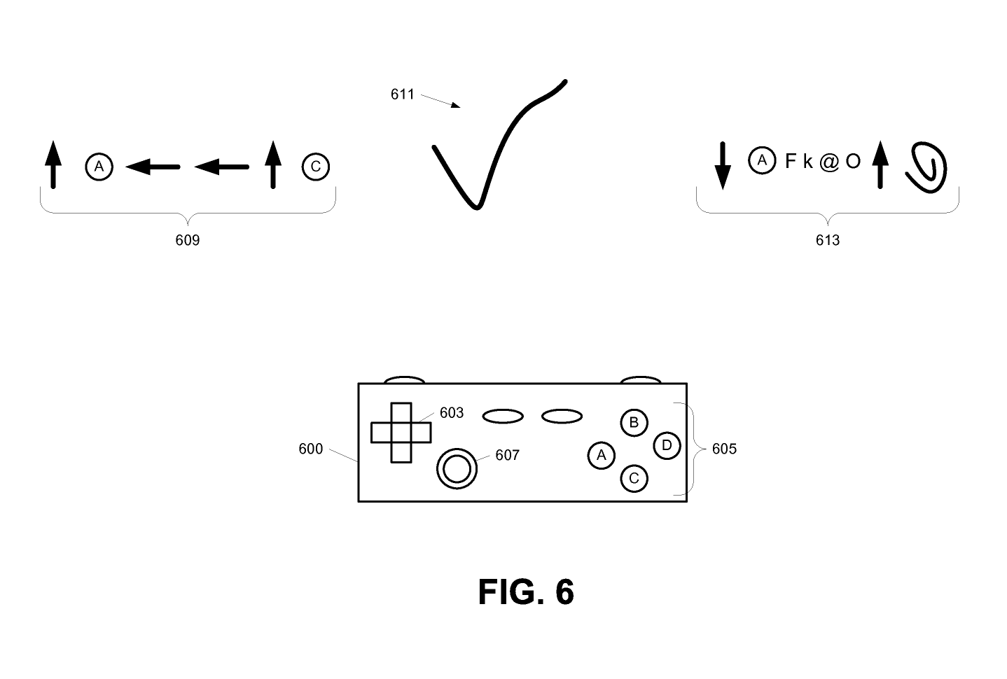

FIG. 6 illustrates various types of passwords or credentials that may be used to verify a user. For example, controller 600 may include a series of directional buttons 603, color coded and letter coded buttons 605, a joystick 607 and one or more motion sensing components (not shown). As illustrated, a user may enter a password 609 including presses of the directional buttons 603 and color and letter coded buttons 605. The same or a different user, on the other hand, may enter a password 611 that is based solely on a motion such as a check mark entered using joystick 607 or movement of the controller 600. Alternatively or additionally, a combination of alphanumeric characters, buttons 603 and 605 and motions may be used, as shown in password 613. A duration of a button press may also be specified as part of a password.

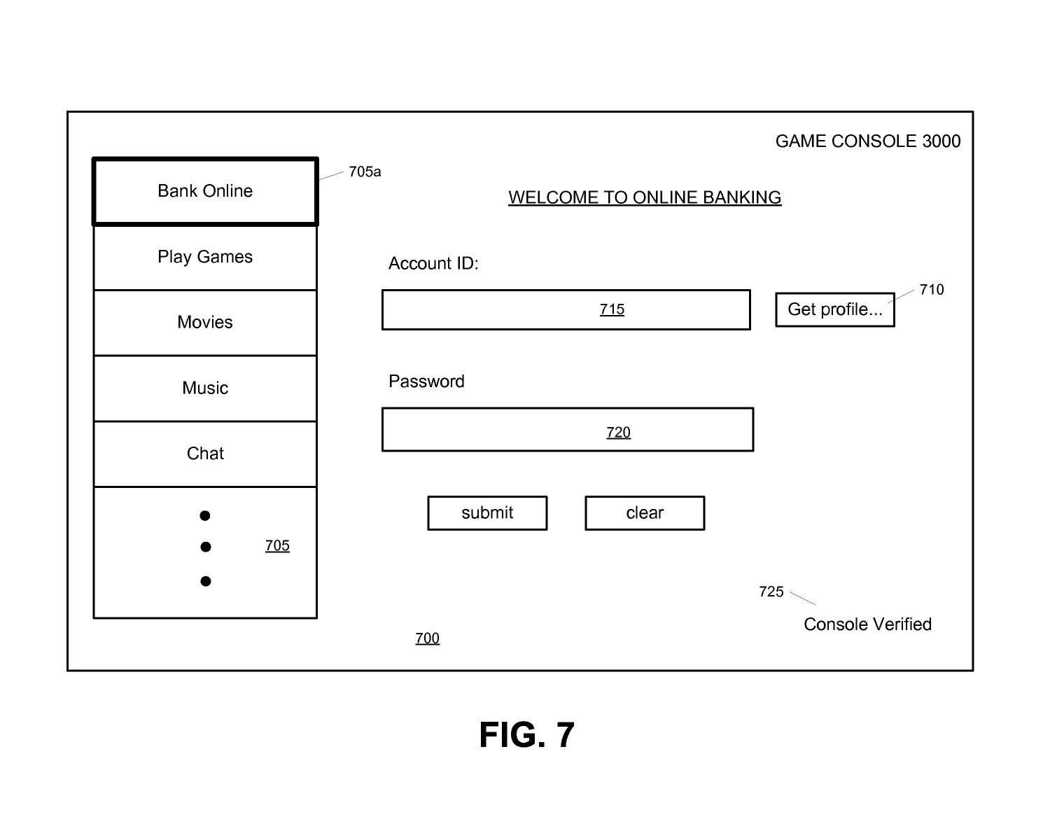

FIG. 7 illustrates a login interface for online banking access. Interface 700 includes a menu bar 705 including multiple activity options such as Bank Online option 705a. Upon selection of option 705a, interface 700 may include account and password entry fields 715 and 720, a get profile option 710 and a console integrity verification indicator 725. Console integrity verification indicator 725 provides users with a notification of whether the console was verified as valid. In some instances, indicator 725 may indicate that the console was removed without authorization and/or was not verified. In such cases, a user might not be allowed to login to online banking (e.g., fields 715 and 720 may be deactivated or grayed out). Get profile option 710 allows a user to choose a gamer or banking profile. Profiles may be used to store account IDs, passwords, banking preferences and configurations and the like. Alternatively, a user may manually enter account ID and password information without selection of a profile.

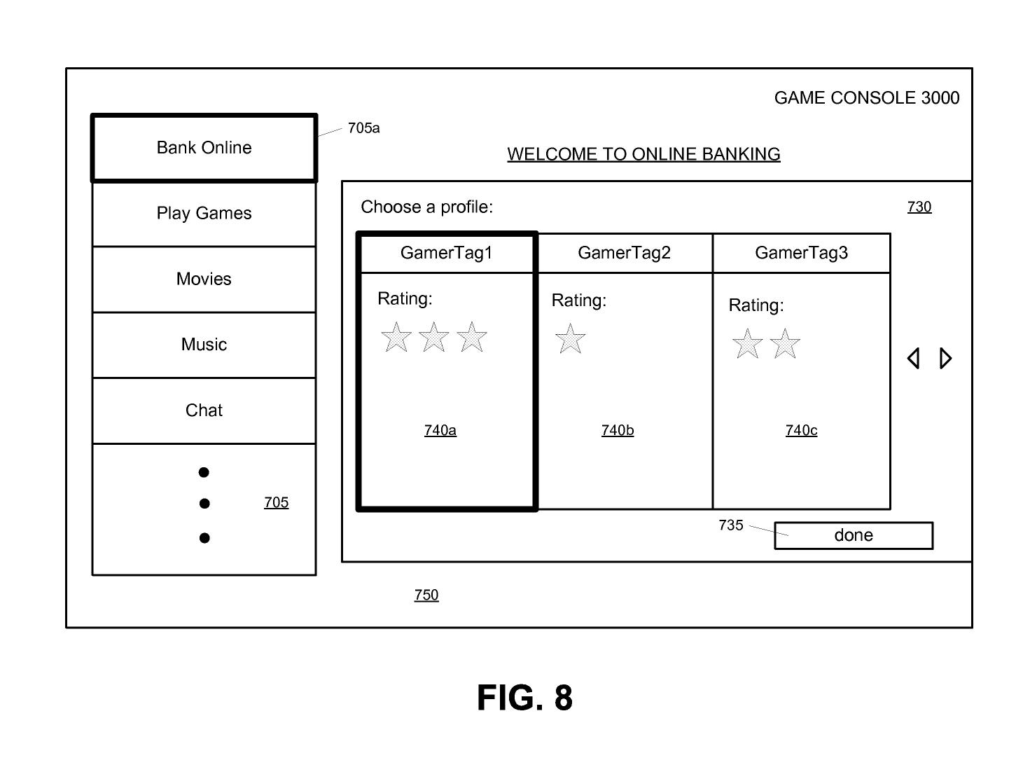

FIG. 8 illustrates a profile selection interface for selecting an online banking profile. Profile selection interface 750 may be displayed in response to a user selecting a get profile option such as option 710 of FIG. 7. A profile selection menu 730 may be displayed with multiple selectable profiles 740. Each profile in menu 730 may provide information about that profile including a gamer tag or account ID and a rating. The rating may correspond to a number of games played, a proficiency of a user associated with the profile in one or more games, frequency with which a user uses one or more application (e.g., a particular game or the online banking application) and the like. Upon highlighting or selecting the desired profile, a user may select done 735 to finalize the choice and return to the login screen. Alternatively or additionally, upon selecting a desired profile, the user may be automatically logged in.

Any number of credentials may be used in accordance with the aspects described herein. Thus, credentials in addition to console specific and user specific credentials may further be required and validated before access is granted by a financial institution. For example, other credentials may include a code or password generated by a device that is configured to change or update the code or password at predefined times (e.g., every 30 seconds). Thus, a console may be required to submit user specific credentials, console specific credentials and a code or password generated by another device (i.e., other than the console).

Although not required, one of ordinary skill in the art will appreciate that various aspects described herein may be embodied as a method, a data processing system, or as one or more computer-readable media storing computer-executable instructions. Accordingly, those aspects may take the form of an entirely hardware embodiment, an entirely software embodiment or an embodiment combining software and hardware aspects. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A method comprising:
registering, by a special-purpose gaming console, one or more credentials specific to the gaming console with a gaming service provider;
executing, by the special-purpose gaming console, a banking application specific to a remote financial institution different from the gaming service provider;
receiving, by the special-purpose gaming console through the banking application, a selection of a user profile from a plurality of user profiles stored in the special-purpose gaming console;
establishing, by the banking application executing on the special-purpose gaming console, a network connection to a remote financial institution;
retrieving user profile information specific to the financial institution from the selected user profile;
transmitting, by banking application executing on the special-purpose gaming console, an authorization request to access a financial account to the remote financial institution through the network connection, the request including one or more credentials specific to the gaming console and the retrieved user profile information; and
in response to the authorization request, receiving, from the remote financial institution, authorization to access the financial account through the gaming console, the authorization indicating that the one or more credentials specific to the gaming console was verified.

2. The method of claim 1, wherein the authorization request further includes one or more credentials specific to a user and wherein the authorization further indicates that the one or more credentials specific to the user was verified.

3. The method of claim 2, wherein the one or more user specific credentials are determined from the selected user profile.

4. The method of claim 1, wherein the one or more credentials specific to the gaming console is hardcoded into at least one hardware component of the gaming console.

5. The method of claim 4, further comprising verifying the integrity of the gaming console based on the one or more credentials specific to the gaming console, wherein the integrity of the gaming console includes whether the gaming console has been stolen.

6. The method of claim 5, wherein verifying the integrity of the gaming console includes sending a verification request to a remote gaming service provider.

7. The method of claim 1, wherein the special-purpose gaming console is a hardened device.

8. The method of claim 1, wherein the authorization request is transmitted to the financial institution through a remote gaming service provider.

9. A method comprising:
receiving, by a system having at least one processor at a financial institution, a request to access a financial account of a user from a special-purpose gaming console, wherein the request includes one or more credentials specific to the gaming console;
verifying, by the system, validity of the one or more credentials specific to the gaming console by querying a gaming service provider using the one or more gaming console-specific credentials;
if the validity of the one or more credentials specific to the gaming console is verified by the gaming service provider:
validating, by the system, one or more user specific credentials of the user; and
in response to validating the one or more user specific credentials, granting, by the system, access to the financial account, wherein verifying that the one or more credentials specific to the gaming console are valid includes receiving a confirmation of validity from the gaming service provider,
otherwise, denying access to the financial account.

10. The method of claim 9, wherein the one or more credentials specific to the gaming console is hardcoded into at least one hardware component of the gaming console.

11. The method of claim 9, further comprising:
receiving the one or more credentials specific to the user as part of the request.

12. The method of claim 9, wherein the one or more credentials specific to the user includes a game account identifier.

13. The method of claim 9, wherein the one or more user specific credentials includes a passcode comprising input corresponding to depression of a directional key of a game controller.

14. The method of claim 9, wherein the special-purpose gaming console is a hardened device.

15. A method comprising:
receiving, by a special-purpose gaming console, a request to access a financial account;
verifying, by a banking application executing on the special-purpose gaming console, the integrity of the gaming console by querying a remote gaming server;
if the integrity of the gaming console is verified:
establishing, by the banking application executing on the special-purpose gaming console, a network connection with a remote financial institution associated with the financial account in response to verifying the integrity of the gaming console;
transmitting, by the banking application executing on the special-purpose gaming console, an authorization request to access the financial account to the remote financial institution through the network connection, the request including one or more credentials hardcoded in the gaming console; and
in response to the authorization request, receiving, from the remote financial institution, authorization to access the financial account through the gaming console, the authorization indicating that the one or more credentials hardcoded in the gaming console were verified,
otherwise, denying access to the financial account.

16. The method of claim 15, wherein the one or more credentials hardcoded in the gaming console includes a console identifier unique to the gaming console.

17. The method of claim 15, wherein the authorization request further includes one or more user specific credentials and wherein the authorization to access the financial account further indicates that the one or more user specific credentials were verified.

18. The method of claim 17, wherein the one or more user specific credentials include a password comprising a motion.

19. The method of claim 15, wherein verifying the integrity of the gaming console includes receiving a confirmation from the remote gaming server that the gaming console has not been compromised.

20. The method of claim 15, wherein the network connection is established over a gaming network.

21. The method of claim 9, wherein the request to access the financial account of the user is received from the special-purpose gaming console through the gaming service provider server upon verification of the integrity of the special-purpose gaming console by the gaming service provider, wherein the gaming service provider server is different from the special-purpose gaming console and the financial institution system.
